(19) United States
(12) Patent Application Publication
(10) Pub. No.: US 2004/0204103 A1
(43) Pub. Date: Oct. 14, 2004

(54) Adaptive beamforming in a wireless communication system

(76) Inventor: Antoine J. Rouphael, Escondido, CA (US)

Correspondence Address: Siemens Corporation, Attn: Elsa Keller, Legal Administrator, Intellectual Property Department, 186 Wood Avenue South, Iselin, NJ, 08830, US

(21) Appl. No.: 10/100,452

(22) Filed: Mar. 18, 2002

(51) Int. Cl. H04M 1/00

(52) U.S. Cl. 455/562.1; 455/561

(57) ABSTRACT

A method of transmitting information between a transmitting station having an adaptive antenna array and a receiving station in a wireless communication system. The method includes the steps of generating default weight vectors for the antenna array of the transmitting station, transmitting the weight vector to the receiving station, modifying the weight vector in the receiving station, re-transmitting the modified weight vector to the transmitting station, and adapting the adaptive antenna array according to the modified weight vector within the transmitting station.

### BACKGROUND OF THE INVENTION

The present invention relates generally to a method and apparatus for handling adaptive beamforming in a wireless communication system.

Wireless technology provides multiple applications for voice and/or video and/or data transmission. Today's cell phone network providers offer a variety of services for their customers including digital data services, such as digital email, Internet access, etc. In future applications, such as third and fourth generation wireless networks, many new digital data services will be provided. In particular, Internet applications will be highly improved and made more practical, for example, via high speed digital data transmission. Other digital data applications, not yet applicable in today's wireless transmission technology, will be adapted and implemented.

With these improved services, more mobile devices such as personal digital assistants (PDAs), laptop computers with an integrated communication device, multi-function cellular phones, etc. will become available. The more devices are operated in a wireless communication environment, the more it is necessary to secure proper communication between a base station and a particular mobile device. The base station is usually responsible for a specific area whose size is defined by the environmental parameters and whose transmitting and receiving capabilities depend on the average number of mobile devices used in that specific area. Many parameters influence the quality of a connection between a mobile device and a base station, such as buildings in that specific area, interference with other transmission systems, etc.

Beamforming is a known technique to improve the connection between a mobile device and a base station. This technique allows an antenna to send a more directional transmission beam to a respective device in order to avoid coverage of most areas where no transmission is needed. Similarly, a directional antenna may be used by the receiver to improve the signal-to-interference ratio by nulling out any interference from unwanted transmitters. However, only rough estimates about the size and form of such a transformed beam can be made in today's system.

Therefore, there is a need for an improved method and apparatus for beamforming in a wireless communication system.

### SUMMARY OF THE INVENTION

According to a specific embodiment, the present invention provides a method of transmitting information between a transmitting station having an adaptive antenna array and a receiving station in a wireless communication system. The method includes the steps of generating default weight vectors for the antenna array of the transmitting station, transmitting the weight vector to the receiving station, modifying the weight vector in the receiving station, re-transmitting the modified weight vector to the transmitting station, and adapting the adaptive antenna array according to the modified weight vector within the transmitting station.

According to another specific embodiment, the present invention provides a method of transmitting information between a transmitting station having an adaptive antenna array and a receiving station having an adaptive antenna array in a wireless communication system. The method includes the steps of generating default weight vectors for the antenna array of the transmitting and the receiving station, transmitting the weight vectors to the receiving station, modifying the weight vectors in the receiving station, re-transmitting the modified weight vector of the transmitting station to the transmitting station, and adapting the adaptive antenna array according to the modified weight vector within the transmitting station.

According to anther specific embodiment, the present invention provides a transceiver station for communication within a wireless communication system. The transceiver station includes an adaptive antenna array including multiple antenna elements for communication with another transceiver station. The station also includes a controller for receiving and transmitting a digitized data stream coupled with the adaptive antenna array for receiving a data stream from the antenna array transmitted by another transceiver station. The data stream includes weight vector information. The station further includes a weight modification unit within the controller for modifying the received weight vector information, with the controller retransmitting the modified weight vector information to another transceiver station.

A more complete understanding of the present disclosure and advantages thereof may be acquired by referring to the following description taken in conjunction with the accompanying drawings, in which like reference numbers indicate like features.

### BRIEF DESCRIPTION OF THE DRAWINGS

FIG. 1 shows a block diagram of a wireless communication system showing a base station and one mobile device;

FIG. 2 shows an exemplary data frame used for communication between transmitting and receiving device, according to a specific embodiment;

FIG. 3 shows a block diagram an adaptive antenna array, according to a specific embodiment; and

FIGS. 4A-4C show different scenarios in a wireless communication system according to specific embodiments of the present invention.

### DETAILED DESCRIPTION OF SPECIFIC EMBODIMENTS

According to a specific embodiment, the present invention provides a method of transmitting information between a transmitting station having an adaptive antenna array and a receiving station in a wireless communication system. The method includes the steps of generating default weight vectors for the antenna array of the transmitting station, transmitting the weight vector to the receiving station, modifying the weight vector in the receiving station, re-transmitting the modified weight vector to the transmitting station, and adapting the adaptive antenna array according to the modified weight vector within the transmitting station.

According to another specific embodiment, the present invention provides a method of transmitting information between a transmitting station having an adaptive antenna array and a receiving station having an adaptive antenna array in a wireless communication system. The method includes the steps of generating default weight vectors for the antenna array of the transmitting and the receiving station, transmitting the weight vectors to the receiving station, modifying the weight vectors in the receiving station, re-transmitting the modified weight vector of the transmitting station to the transmitting station, and adapting the adaptive antenna array according to the modified weight vector within the transmitting station.

The modifying, re-transmitting, and adapting steps of the above methods can be repeated during transmission by the transmitting station, according to specific embodiments. Furthermore, the transmission can include digitized voice, data and/or video information. The modification of the weight vector can be performed by determining a reception error in the receiving station whereby the error vector can be multiplied by the received data vector and added to the weight vector. Furthermore, the addition to the weight factor can be multiplied by an adaptive rate factor.

The methods can also include the steps of calculating a weight vector for the antenna of the receiving station within the receiving station, transmitting the weight vectors from the receiving station to the transmitting station if the receiving station becomes the transmitting station, and repeating the modifying, re-transmitting and adapting steps. The communication protocol can be chosen from the group of communication technologies of UMTS, CDMA, TDMA, GSM, OFDM, or FDMA based technologies. Also a step of determining separate weight vectors for transmission and reception characteristics of said antenna array in the receiving station can be provided wherein a step of modifying the weight vector for the reception characteristics by the determined error can be included. Another embodiment of the present invention is shown as a transceiver station for communication within a wireless communication system. The transceiver station includes an adaptive antenna array comprising a plurality of antenna elements for communication with another transceiver station, a controller, and a weight modification unit within the controller. The controller for receiving and transmitting a digitized data stream is coupled with the adaptive antenna array for receiving from the antenna array a data stream transmitted by the another transceiver station. The data stream includes weight vector information. The weight modification unit modifies the received weight vector information, and the controller retransmits the modified weight vector information to another transceiver station.

According to a specific embodiment, the weight modification unit further can comprise an adder unit and a multiplication unit for adding an error vector multiplied by a received data vector to the weight vector. The multiplication unit can further multiply the error vector by an adaptive rate factor. The transceiver station can be a base station or a mobile device.

FIG. 1 shows a general block diagram according to the present invention. According to the present invention, a wireless communication system comprises a plurality of base stations 100 each responsible for communication in a particular area and a plurality of mobile stations 150. Each base station 100 comprises a base station controller 110 which receives and transmits a data signal 115 to and from a respective processing unit (not shown in FIG. 1). The base station controller is coupled to an adaptive antenna array 120 having a plurality of antenna elements 125a, 125b, . . . 125n. The exemplary mobile device 150 has a similar structure. Also provided is a mobile device controller 170 which receives and transmits a data stream from and to a respective processing unit (not shown in FIG. 1). The mobile device controller 170 is also coupled to an antenna driver 160. The actual antenna of the mobile device can be a single element antenna 165a or an antenna array comprising a plurality of antenna elements 165a, 165b, . . . 165n (as indicated by the dotted antenna elements in FIG. 1).

It is assumed that such a system, for example, a fourth generation wireless system, operates with a great number of mobile users operating both data and voice/video applications. As mentioned above, a mobile device in such a wireless system can be a PDA, a laptop, an advanced cell phone having picture phone capabilities, etc. This will increase the number of users and the stringent performance required of future devices. To achieve the required capacity and performance, source and channel coding along with respective transmission methods need to be improved. One example of improving the transmission method is to use a space division multiple access scheme. Within a transmission area of a base station, also called a “cell”, a spatial filtering is used to minimize inter- and intra-cell interference. To this end, a sectorized antenna array is used wherein a plurality of fixed sectors within a cell are covered. However, a more sophisticated way of controlling an antenna array is by using a digital beamforming technique. Thus, the beam can be adapted to the area to be covered more flexibly and accurately.

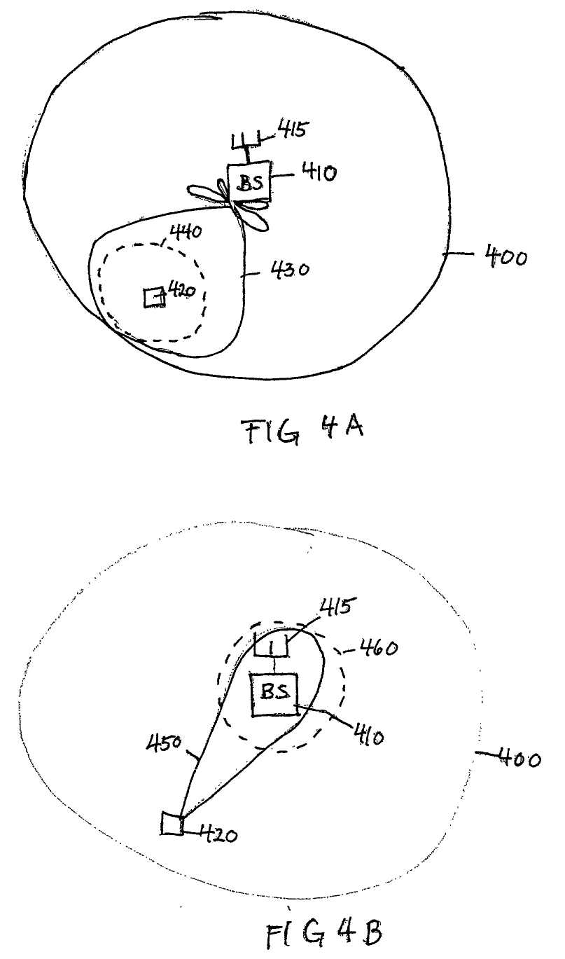

A specific embodiment of such an antenna array, usable within a base station as well as in a mobile device, is shown in FIG. 3. FIG. 3 shows only the transmitting part of such an antenna system. The receiving part can be formed in a similar complementary way. Antenna array 310 may include a plurality of antenna segments 315a, 315b, . . . 315n and appropriate driver circuitry. A signal sample generator 330 receives a digital signal to be sent to a remote receiving unit. Signal sample generator 330 generates a plurality of digital signals for each antenna element K and these digital signals are respectively multiplied at multiplier 325a, 325b, . . . 325n by weight vectors. Thus, the linear combination of the data at the K^{th} sensor can be expressed as:

$${y}_{n} ( θ ) = {\sum }_{k = 0}^{K - 1} {w}_{k} ( n ) {x}_{k} ( n ) \qquad ( 1 )$$

where wₖ(n) is the complex weight at the k^{th} element convolved with xₖ(n) which is the nth sample of the incoming signal at the k^{th} antenna array element. In matrix form, the relation in equation (1) may be written as:

yₙ(θ)=W^{H}(n)X(n) (2)

where W is a weight vector and X is a data vector both defined as

$$X ( n ) = [ \begin{matrix}{x}_{1} ( n ) \\ {x}_{2} ( n ) \\ ⋮ \\ {x}_{K} ( n )\end{matrix} ] and W ( n ) = [ \begin{matrix}{w}_{1} ( n ) \\ {w}_{2} ( n ) \\ ⋮ \\ {w}_{K} ( n )\end{matrix} ] \qquad ( 3 )$$

and H signifies a Hermitian transpose.

According to the present invention, the antenna array of both the base station and the mobile device can be mutually adaptively adjusted by means of beamforming to improve the transmission quality and reduce interference with other mobile devices and/or other wireless systems. In a first embodiment of the present invention, both the antenna array of the base station and of the mobile device can be mutually adapted. The antenna array of the base station and the mobile device can both be adapted using one adaptive algorithm. The mobile device comprises multiple single antenna segments, for example, three antenna segments which are arranged within the housing of the device, for example a laptop computer. It will be assumed that the underlying wireless system to be a wideband code division multiple access (CDMA) system, for example, a universal wireless telecommunication system (UMTS) using time division duplexing (TDD) as its main mode of operation, according to a specific embodiment. In TDD mode, the forward and reverse link channels use the same frequency. Therefore, the spatial channel characteristics are assumed to be reciprocal for both transmit and receive modes. In order to obtain the optimal set of weights to adapt the smart antenna arrays at both the base station and the mobile device, a common error vector will be used. The principle according to the present invention is to optimize the transmitting antenna and the receiving antenna for best performance. Therefore, a set of weight vectors at both systems are generated, such that the transmit beam and the receiving beam are adapted simultaneously. Both systems thus keep a proprietary weight vector and a weight vector for the transmitting system. Therefore, there will be two sets of weights—one that performs optimally for the base station and one that performs optimally for the user station.

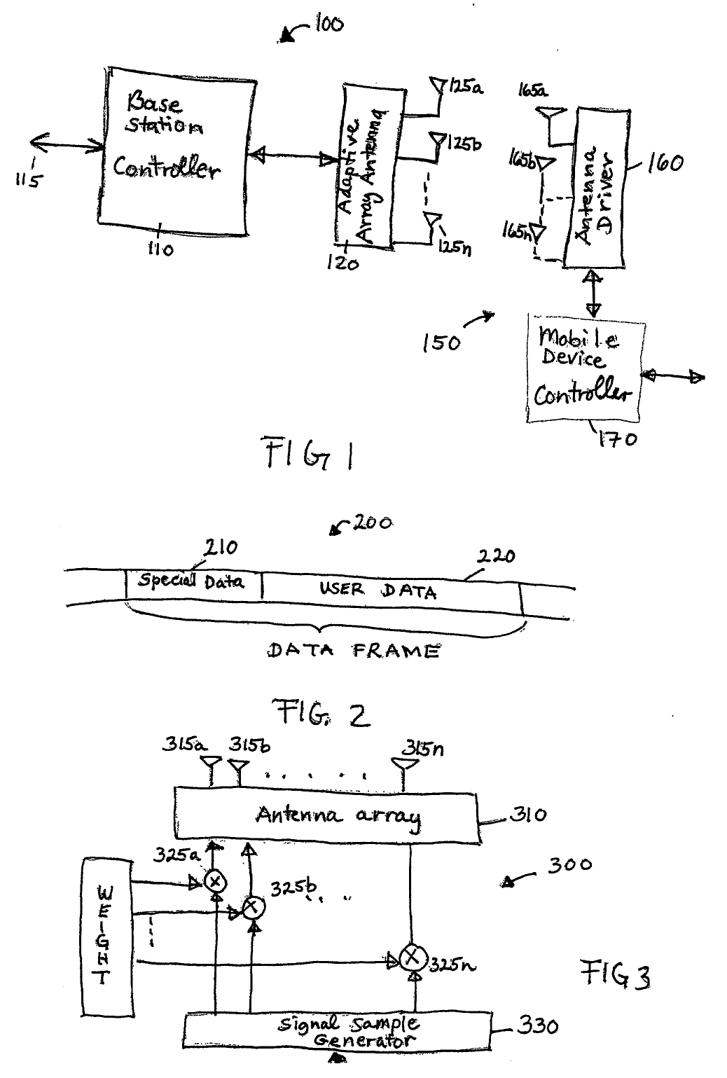

The error vector will be generated in the receiving station. Different modes of adaptation can be implemented according to the present invention. For example, an adjustment procedure can be invoked at predefined time periods. During these adjustment procedures, the error is generated. In another mode, the adjustment can be performed constantly. Within transmitted data frames, for example, special data can be included which allow communication of the relevant data for performing a continuous adjustment. FIG. 2 shows an exemplary data frame which can be used in such a system. A data frame 200 includes a first section comprising special data 210 followed by user data 220 which contain the sampled voice and/or video data or pure data depending on the application. The special data can contain test data which is known to the receiver for transmission quality evaluation and any kind of other controlling system data necessary to run the transmission procedure, such as synchronizing information. The special data and the user data can be arranged in any way within a data frame. For example, a plurality of special data sub-frames and user data sub-frames can be convoluted within a transmission frame.

According to a specific embodiment, the adaptation is performed as follows. Assuming that W( ) and X( ) are the weight and received data vectors at the base station, respectively and V( ) and Y( ) are the weight and received data vectors at the user station. Thus, the base station has a set W_{b}( ) and V_{b}( ) weights indicated by the subscript letter b and the mobile station has a set of weights Wₘ( ) and Vₘ( ) indicated by the subscript letter m. Furthermore, it will be assumed that the mobile device is the receiving station and the base station is the transmitting station. The error can now be generated using known pilot symbols alone or in a data mode where both data and pilot symbols are used. Using pilot symbols means that both systems know the data that is sent. However, a blind adaptation can also be used with test or regular data transmitted over the system. As mentioned above, the pilot symbols as well as the weight vectors can be transmitted in the special data sub-frame.

After calculation of the vectors and application of the proprietary vector, the modified or updated vector for the transmitting station is transmitted back from the receiving station (for example, the mobile station to the base station) during a communication confirmation handshake procedure. The base station then uses this vector to adapt its own antenna array. Thus, the antenna array of the transmitting station is constantly adapted to the potentially changing receiving conditions of receiving station. Whenever the receiving station switches over to transmitter mode, it calculates a new set of vectors based on the received set thereby updating the vector set. These vectors are transmitted to the now receiving station which will then calculate a new vector for the now transmitting mobile station. The adaptive weights are updated as follows assuming that the mobile device is the transmitting device:

$$[ \begin{matrix}W ( n + 1 ) \\ V ( n + 1 )\end{matrix} ] = [ \begin{matrix}W ( n ) \\ V ( n )\end{matrix} ] + {μ}_{m} {e}_{m} ( n ) Y ( n ) \qquad ( 4 )$$

where μₘ is the adaptive rate factor and eₘ( ) is the error generated at the mobile device. The updated base station weight W(n+1) is constantly sent back to the transmitter for adaptation of its antenna array. Whenever the transmitting/receiving situation reverses, the base station weight W(n+1) and the mobile station weight V(n+1) are transmitted to the base station for further adaptation. Then the following procedure applies:

$$[ \begin{matrix}W ( n + 2 ) \\ V ( n + 2 )\end{matrix} ] = [ \begin{matrix}W ( n + 1 ) \\ V ( n + 1 )\end{matrix} ] + {μ}_{b} {e}_{b} ( n + 1 ) X ( n + 1 ) \qquad ( 5 )$$

where μ_{b} is the adaptive rate factor and e_{b}( ) is the error generated at the base station. The mobile station weight V(n+2) is then transmitted after each modification back to the mobile device for adaptation of its antenna array. Whenever, the transmitting/receiving constellation is reversed again, the weight vectors W( ) and V( ) are transmitted back to the mobile station and the procedure switches back to the equation (4).

Table 1 shows a time slot scheme showing the method according to an exemplary embodiment of the present invention: during slot 1 at time n, it is assumed that the base station is in receiving mode. The base station then uses its own set of weights W_{b}(n) and V_{b}(n) and its error e_{b}(n) determined at that time to generate new weights W_{b}(n+²) and V_{b}(n+2). Its own vector W_{b}(n+2) is applied to adjust its receiving characteristics for the antenna whereas the newly determined weight V_{b}(n+2) is transmitted during the next slot to the mobile station where it will be received and used to adjust the transmitting characteristic of the mobile antenna array. This adjustment will be effective in slot 3. Therefore, assuming that there have been previous slots, the base station will receive a weight Wₘ(n+1) previously determined by the mobile station. This weight Wₘ(n+1) is applied to the antenna array to adjust its transmitting characteristics which will be effective during transmission by the base station in slot 2.

Likewise, in slot 2, the mobile station receives the previously transmitted V_{b}(n+2) and uses its own set of weights Wₘ(n+1) and Vₘ(n+1) and the error eₘ(n+1) that have been determined at that time to generate new weights Wₘ(n+3) and Vₘ(n+3). Again, the mobile station's own vector Vₘ(n+3) is applied to adjust its receiving characteristics for the antenna; whereas, the newly determined weight Wₘ(n+3) is transmitted during the next slot to the base station where it will be received and used to adjust the transmitting characteristic of the base antenna array.

Slots 3, 4 and following slots will operate in a similar manner. The receiving station thus always determines the characteristics of the antenna array of the transmitting station. The scheme shown in Table 1 comprises, therefore, a convoluted adjustment method in which both the mobile station and the base station mutually adapt their antenna arrays according to the characteristics of the transmission channel.

TABLE 1

| | | | | |
|---|---|---|---|---|
| Time = n | n + 1 | n + 2 | n + 3 | . . . |
| Slot 1 | Slot 2 | Slot 3 | Slot 4 | . . . |

| | | | |
|---|---|---|---|
| Base station | Mobile station | Base station | Mobile station |
| receiving | receiving | receiving | receiving |
| Use W_{b}(n) and | Use Wₘ(n + 1) | Use W_{b}(n + 2) | Use Wₘ(n + 3) |
| V_{b}(n) and e_{b}(n) | and Vₘ(n + 1) | and V_{b}(n + 2) | and Vₘ(n + 3) |
| to produce | and eₘ(n + 1) | and e_{b}(n + 2) | and eₘ(n + 3) |
| W_{b}(n + 2) and | to produce | to produce | to produce |
| V_{b}(n + 2) | Wₘ(n + 3) and | W_{b}(n + 4) and | Wₘ(n + 5) and |
| which will be | Vₘ(n + 3) | V_{b}(n + 4) | Vₘ(n + 5) |
| effective in | which will be | which will be | which will be |
| slot 3 | effective in | effective in | effective in |
| Transmit | slot 4 | slot 5 | slot 6 |
| V_{b}(n + 2) to | Transmit | Transmit | Transmit |
| the mobile | Wₘ(n + 3) to | V_{b}(n + 4) to | Wₘ(n + 5) to |
| station | the base station | the mobile | the base station |
| | | station | |

where Wₘ( ) is the base station weight when the base station is transmitting, Vₘ( ) is the mobile station weight when the mobile station is receiving, eₘ( ) is the error generated at the mobile station when the mobile station is receiving, W_{b}( ) is the base station weight when the base station is receiving, V_{b}( ) is the mobile station weight when the mobile station is transmitting, and e_{b}( ) is the error generated at the base station when the base station is receiving.

The method according to the present invention adapts the antenna arrays at both ends of the communication link. This method can be extended to technologies other than TDD-UMTS. It can be used in CDMA, time division multiple access systems (TDMA), global system for communication (GSM), orthogonal frequency division multiplexing systems (OFDM), frequency division multiple access (FDMA)-based technologies, etc.

In another embodiment of the present invention, only the antenna array of the base station can be adapted. The mobile device includes only a single antenna segment, making beamforming not possible. There can be multiple reasons for only providing a single antenna element, such as space requirements, possible interference with other components, etc. However, the method and apparatus according to the present invention also can be applied to such a system. In this case, the antenna within the mobile device cannot be adapted with respect to any beamforming functions. However, some parameter affected by a weight vector Y( ) could still be adjusted according to the above method. For example, the transmitting power responsible for the transmission distance could be adjusted when a mobile device is very close to a base station, thus avoiding interference with other mobile devices.

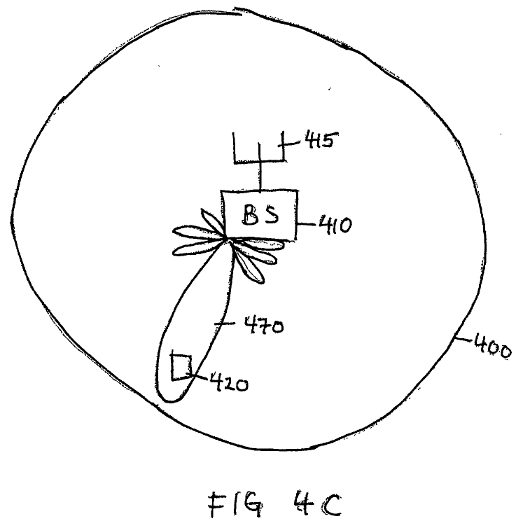

FIGS. 4A-4C show different scenarios during a simplified adaptation process of a wireless system according to the present invention. FIG. 4A shows a typical coverage area or cell 400 of a base station 410 and its associated antenna array 415. Within this cell 400 is a mobile device 420 which is about to communicate with the base station 410. Through a prior registration procedure the base station knows approximately where the particular mobile device is located. To this end, a plurality of procedures can be used. For example, time differences of incoming transmissions between the different antenna elements can be used to determine the position of each mobile device within a specific cell. If the base station 410 is about to start a communication process with the mobile device 420, a first rough beamforming takes place to create a beam covering, for example, area 430. Any other initial coverage can be used to start the communication process. During this first communication attempt, base station 410 submits its set of predefined weight vectors W(n) and V(n) which were created during the prior registration procedure. If mobile station 420 has moved outside this coverage area, base station 410 will either enlarge its covered area 430 by modified beamforming or scan the cell until the respective device has been located and newly registered.

Initially, mobile device 420 receives through a respective data frame the pre-calculated weight vectors W_{b}( ) and V_{b}( ). It will adjust its own weight vector Vₙ( ) by an appropriate predefined function, for example, equation (3). Any other suitable weight modifying procedure can be implemented. Thus the device's own reception beam is adapted by its own weight vector Vₘ( ). The dotted area 440 indicates, for example, an appropriate reception adaptation by digital beamforming within the mobile device 420. In addition, the weight vector Wₘ( ) will be modified by the mobile device and retransmitted to the base station to adjust the transmitting characteristics of the antenna array of the base station. The effect of this transmission is shown in FIG. 4C.

FIG. 4B shows the transmission by the mobile station. The beamforming is controlled by a previously transmitted weight V_{b}( ) and thus formed according to the parameters to an optimized shape 450. The reception characteristics of the antenna array of the base station 410 have been adjusted according to the previously transmitted weight Wₘ( ) to the optimized area 460.

FIG. 4C shows the adaptation of the transmission beam 430 to a newly formed beam covering area 470 which is much smaller and more directed towards the mobile device 420. All further communication with the base station 410 as a transmitter and the mobile device 420 as a receiver will use these beamforming parameters unless any changes occur which cause modification of the respective weight vectors W( ) and V( ). Once the transmitting/receiving assignment is reversed, the opposite procedure will take place. Now, the mobile device is the transmitter having weight vector W( ) and data vector X( ), and the base station is the receiver having weight vector V( ) and data vector Y( ). However, these weights are different, and although the computation is reciprocal the spatial channel is different.

According to the present invention, the adjustment of the respective beamforming is controlled by the receiving station. The receiving station calculates and thus modifies a respective weight vector of the transmitting device, thus ensuring that the transmitter always adapts to the specific reception condition around the receiving device. For example, when the mobile device is the receiving device and is moved during a communication link, the conditions for proper reception might change due to changes in the environment or because the device is moved outside the area covered by the respective transmission signal. The adaptation procedure according to the present invention constantly adjusts the weight vector controlling the respective digital beamforming in the transmission device. Thus, an optimal connection between the transmitting device and the receiving device can be upheld during communication of the two devices. Interference with other devices communicating with the base station in the same cell can so be minimized or completely avoided. More devices can thus be served without the need to increase power or bandwidth of the respective devices.

The present invention is also not limited to a base station mobile device scenario but can be also extended to communication between two or more mobile devices.

What is claimed is:

1. A method of transmitting information between a transmitting station having an adaptive antenna array and a receiving station in a wireless communication system including the steps of:
a) generating default weight vectors for the antenna array of the transmitting station;
b) transmitting the weight vector to the receiving station;
c) modifying the weight vector in the receiving station;
d) re-transmitting the modified weight vector to the transmitting station;
e) adapting the adaptive antenna array according to the modified weight vector within the transmitting station.

2. The method according to claim 1, wherein steps c) to e) are repeated during transmission by the transmitting station.

3. The method according to claim 1, wherein said transmission includes digitized voice information.

4. The method according to claim 1, wherein said transmission includes digitized voice and video information.

5. The method according to claim 1, wherein said transmission includes digital data information.

6. The method according to claim 1, wherein the modification of the weight vector is performed by determining a reception error in the receiving station.

7. The method according to claim 6, further comprising adding the error vector multiplied by the received data vector to the weight vector.

8. The method according to claim 7, wherein the addition to the weight factor is further multiplied by an adaptive rate factor.

9. The method according to claim 1, further comprising the step of calculating a weight vector for the antenna of the receiving station within the receiving station and transmitting the weight vectors from the receiving station to the transmitting station if the receiving station becomes the transmitting station and repeating steps c) to e).

10. The method according to claim 1, wherein the communication protocol is chosen from the group of communication technologies of UMTS, CDMA, TDMA, GSM, OFDM, or FDMA based technologies.

11. The method according to claim 6, further comprising the step of determining separate weight vectors for transmission and reception characteristics of said antenna array in the receiving station.

12. The method according to claim 11, further comprising modifying the weight vector for the reception characteristics by the determined error.

13. A method of transmitting information between a transmitting station having an adaptive antenna array and a receiving station having an adaptive antenna array in a wireless communication system including the steps of:
a) generating default weight vectors for the antenna array of the transmitting and the receiving station;
b) transmitting the weight vectors to the receiving station;
c) modifying the weight vectors in the receiving station;
d) re-transmitting the modified weight vector of the transmitting station to the transmitting station;
e) adapting the adaptive antenna array according to the modified weight vector within the transmitting station.

14. The method according to claim 13, wherein steps c) to e) are repeated during transmission by the transmitting station.

15. The method according to claim 13, wherein said transmission includes digitized voice information.

16. The method according to claim 13, wherein said transmission includes digitized voice and video information.

17. The method according to claim 13, wherein said transmission includes digital data information.

18. The method according to claim 13, wherein the modification of the weight vector is performed by determining a reception error in the receiving station.

19. The method according to claim 18, further comprising adding the error vector multiplied by the received data vector to the weight vector.

20. The method according to claim 19, wherein the addition to the weight factor is further multiplied by an adaptive rate factor.

21. The method according to claim 13, further comprising the step of transmitting the weight vectors from the receiving station to the transmitting station if the receiving station becomes the transmitting station and repeating steps c) to e).

22. The method according to claim 13, wherein the communication protocol is chosen from the group of communication technologies of UMTS, CDMA, TDMA, GSM, OFDM, or FDMA based technologies.

23. The method according to claim 18, further comprising the step of determining separate weight vectors for transmission and reception characteristics of said antenna array in the receiving station.

24. The method according to claim 23, further comprising modifying the weight vector for the reception characteristics by the determined error.

25. A transceiver station for communication within a wireless communication system comprising:
an adaptive antenna array comprising a plurality of antenna elements for communication with another transceiver station;
a controller for receiving and transmitting a digitized data stream coupled with the adaptive antenna array for receiving a data stream from the antenna array transmitted by said another transceiver station, wherein the data stream includes weight vector information;
a weight modification unit within the controller for modifying the received weight vector information, wherein the controller retransmits the modified weight vector information to said another transceiver station.

26. The transceiver station according to claim 25, wherein the weight modification unit further comprises an adder unit and a multiplication unit for adding an error vector multiplied by a received data vector to the weight vector.

27. The transceiver according to claim 26, wherein the multiplication unit further multiplies the error vector by an adaptive rate factor.

28. The transceiver station according to claim 25, wherein the transceiver station is a base station.

29. The transceiver station according to claim 25, wherein the transceiver station is a mobile device.
